(19) United States
(12) Patent Application Publication
(10) Pub. No.: US 2017/0069158 A1
(43) Pub. Date: Mar. 9, 2017

(54) AUGER AND SLEEVE

(71) Applicant: STANLEY BLACK & DECKER, INC., New Britain, CT (US)

(72) Inventors: Lawrence Edward HARPER, Marietta, GA (US); Christopher Todd WHITE, Kennesaw, GA (US); James Michael RATTEREE, Cartersville, GA (US); John Thomas HURT, Marietta, GA (US)

(73) Assignee: STANLEY BLACK & DECKER, INC., New Britain, CT (US)

(21) Appl. No.: 15/306,353

(22) PCT Filed: Apr. 13, 2015
(86) PCT No.: PCT/US2015/025513

§ 371 Date: Oct. 24, 2016

Related U.S. Application Data
(60) Provisional application No. 61/979,630, filed on Apr. 15, 2014.

(51) Int. Cl. G07F 11/46; G07F 11/42

(52) U.S. Cl. CPC G07F 11/46; G07F 11/42

(57) ABSTRACT

A cartridge for use in a vending machine includes an auger disposed in a cylindrical sleeve.

### CROSS-REFERENCE TO RELATED APPLICATIONS

This application is a continuation of PCT/US2015/025513, filed on Apr. 13, 2015, which claims priority from U.S. Provisional Application No. 61/979,630, filed on Apr. 15, 2014, the disclosure of which is incorporated herein by reference.

### BACKGROUND OF THE INVENTION

Vending very small items has been difficult in the past due to the design and geometry of the vending apparatus. Typically, vending machines use a wire coil rotatably disposed in a channel. As the coil is rotated in the channel, an object disposed in the gap between adjacent loops in the coil is moved along the longitudinal axis of the coil towards an outlet. Unfortunately, when a small item is disposed in the coil for vending, friction between the coil and the item can cause the item to move transversely. If the channel is rectangular, the small item is moved toward the void that occurs between the circular coil and the rectangular channel. Once in the void, the item stops moving toward the coil outlet. In some cases, the small item gets wedged between the coil and the sides of the channel, potentially stopping the machine and requiring a worker to free the small item. If the small item is large enough, it could fall back over the bottom portion of the coil into the following gap. In that case, any inventory control relying on the dispensing a known number of items with each rotation of the coil is disrupted.

Those disadvantages have been overcome in the past by prepackaging the small items. Typically, this has been accomplished by placing the item(s) in a small wrapper or envelope and then inserting the wrapper or envelope into the gap of the coil. The repackaging allows the item(s) to be vended more reliably by the conventional wire coil vending machines. However, while this procedure is effective, repackaging is costly and time consuming.

The present invention overcomes these disadvantages by using an auger and circular sleeve. The auger and sleeve provides the capability to reliably vend very small unpackaged items that couldn't be offered before in conventional vending machines without repackaging. The auger prevents items from tipping over into the adjacent gap and the sleeve eliminates voids.

### BRIEF DESCRIPTION OF THE DRAWINGS

FIG. 1 illustrates an arrangement of coils disposed in a vending tray of a conventional vending machine.

FIG. 2 is an exemplary auger and sleeve according to the present invention.

FIG. 3 illustrates the auger and sleeve of FIG. 2 disposed in the vending tray of an otherwise conventional vending machine.

FIG. 4 illustrates an exemplary auger according to the present invention.

FIG. 5 is an end view of the auger of FIG. 4.

FIG. 6 is a side view of the end plate of the auger of FIG. 4.

FIG. 7 illustrates a drive spindle and drive mechanism.

FIG. 8 illustrates a sleeve for use with the auger of FIGS. 1-2.

### DETAILED DESCRIPTION OF THE DRAWINGS

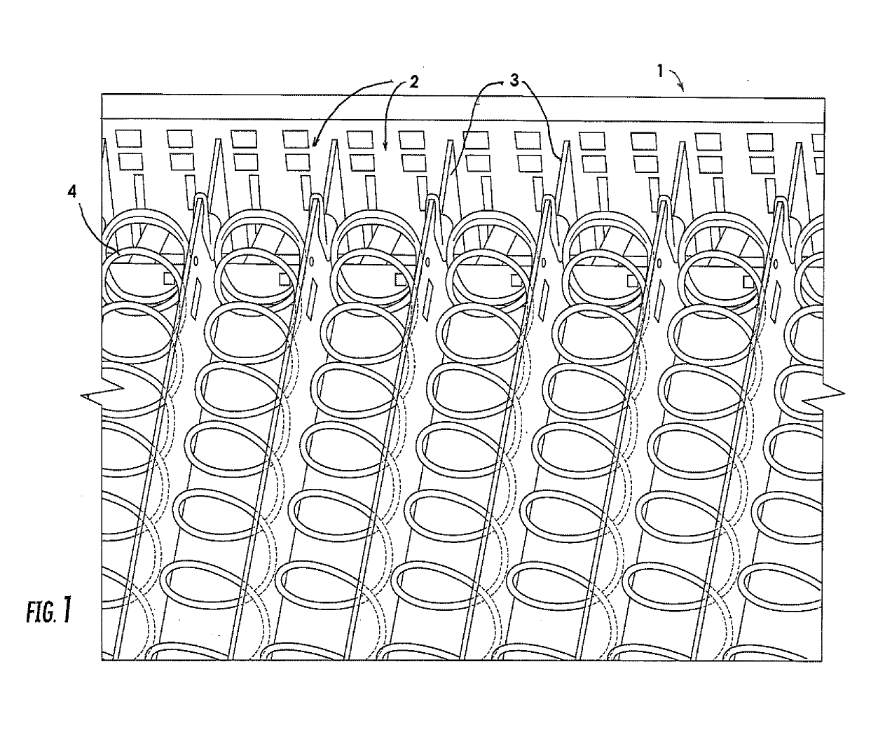

A conventional vending machine, such as shown in FIG. 1, includes a vending tray 1 defining a plurality of channels 2 with each channel being defined by pair of vertical walls 3. A wire coil 4 is disposed in each of the plurality of channels and coupled to a drive mechanism that is configured to rotate the coil in the channel. As the coil is rotated in the channel, an object disposed in the gap between adjacent loops in the coil is moved along the longitudinal axis of the coil towards an outlet.

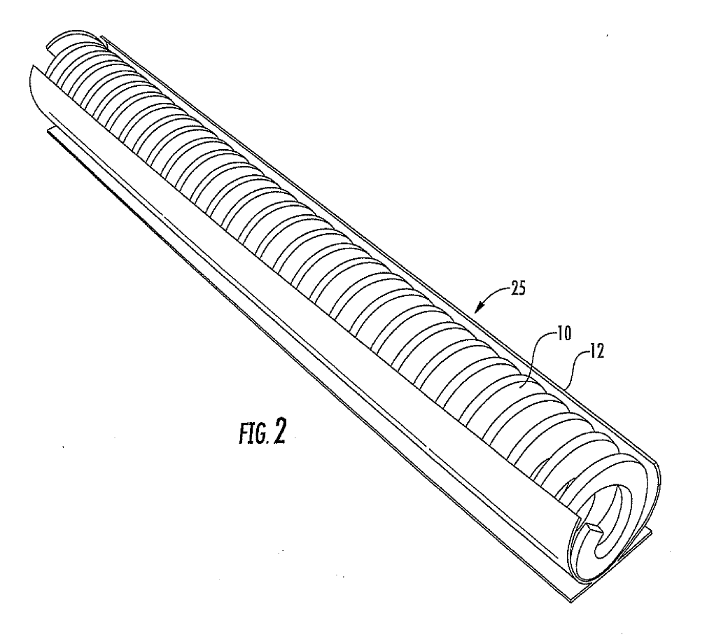

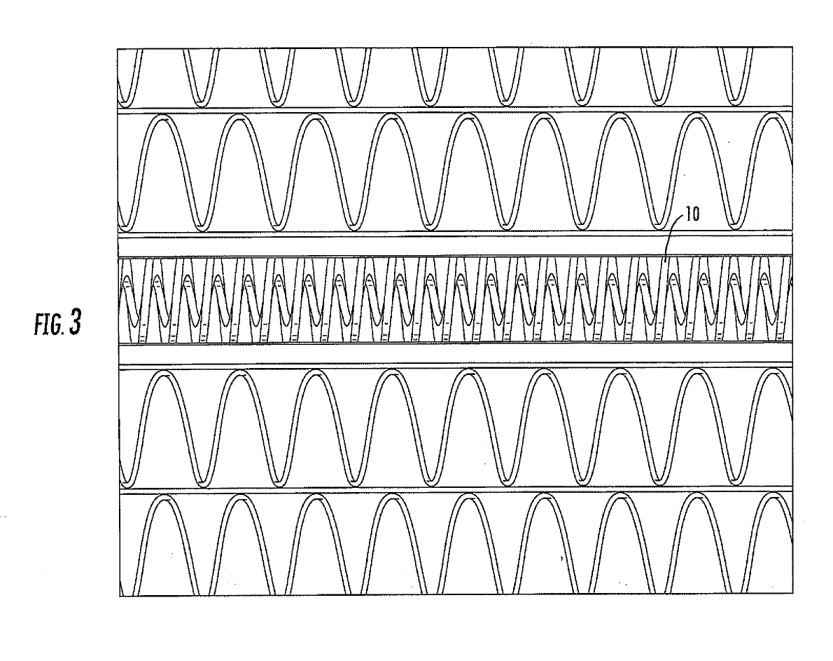

The present invention can include an auger 10 disposed inside a generally cylindrical sleeve 12, as illustrated in FIG. 2. In preferred embodiments, the auger 10 and sleeve 12 form a cartridge configured 25 to drop into one of the channels of the vending tray of a conventional vending machine to replace the wire coil in that channel, as shown in FIG. 3.

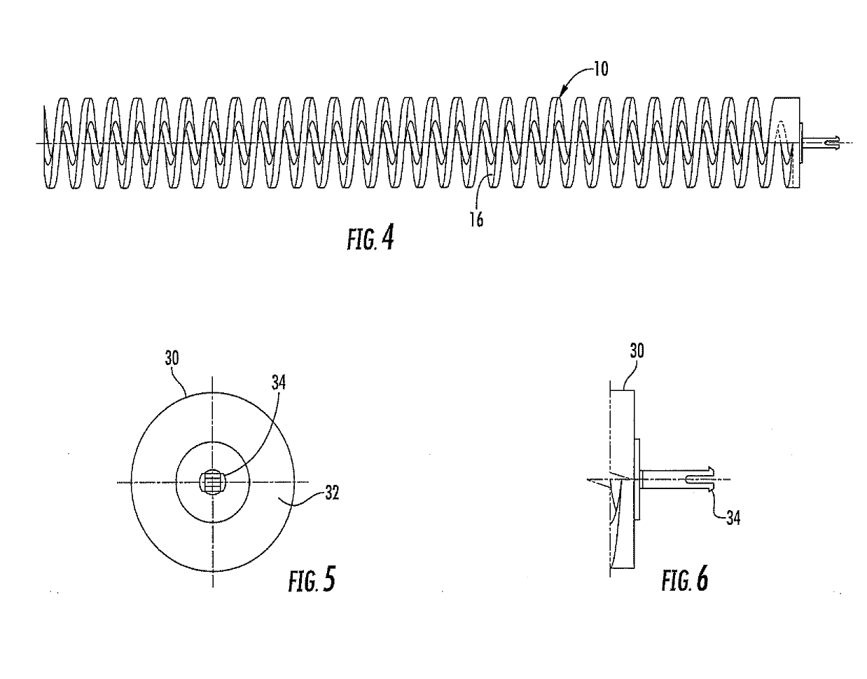

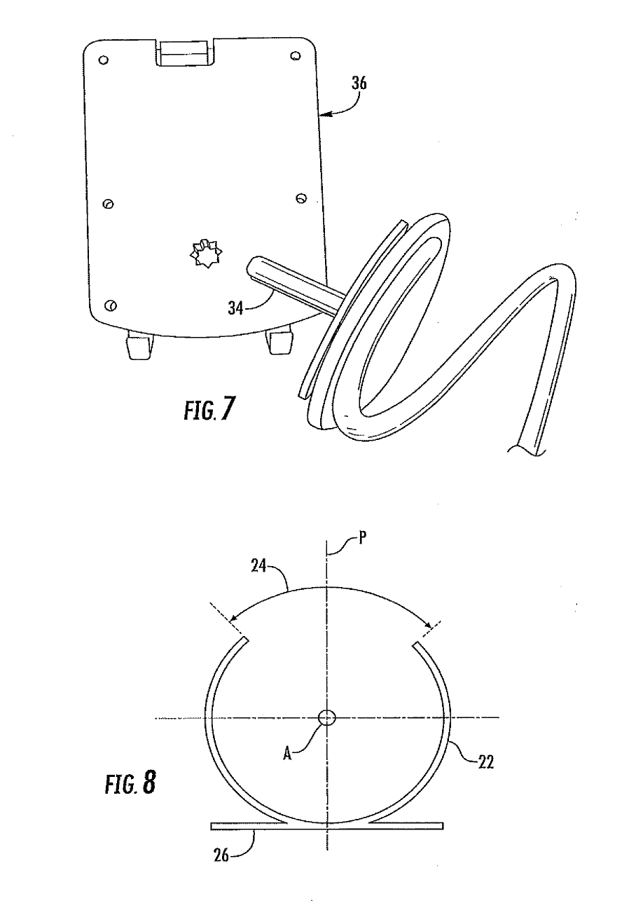

The auger can be made from a continuous ribbon 16 of material. In one exemplary embodiment, as shown in FIG. 4, the ribbon 16 can have a width of about 0.625 inches and be wound about a longitudinal axis A to form a helix having an outside diameter of about 2.5 inches. As shown in FIGS. 5 and 6, the auger 10 can include a first end 30 incorporating a flat plate 32 and a drive spindle 34 extending longitudinally therefrom. The drive spindle 34 can be configured to engage a conventional drive mechanism 36 illustrated in FIG. 7 to rotate the auger 10 relative to the sleeve 12.

The sleeve 12 can include a circular sidewall 22 generally extending parallel to and surrounding the longitudinal axis A. In preferred embodiments, the sidewall 22 includes a gap 24 extending about 25% of the circumference of the sidewall 22, as illustrated in FIG. 8. The gap 24, which can be centered on a plane P extending parallel to the longitudinal axis A, allows convenient access to restock the cartridge without removing the cartridge from the vending machine. The sleeve 12 can further include a base wall 26 extending along a tangent to the sidewall 22 from the intersection of the plane P with the sidewall 22. The length of the base wall 26 can be approximately equal to the outside diameter of the sleeve 12. The inner diameter of the sleeve can be about 2.625 inches to provide a slight clearance between the auger 10 and the sidewall 22 to eliminate binding.

Advantageously, the base wall 26 provides stability to the cartridge 25 to maintain the gap 24 in an orientation to facilitate loading and reloading the cartridge 25 without removing the cartridge 25 from the vending tray.

What is claimed is:

1. A vending machine comprising:
a vending tray;
a plurality of channels formed on the vending tray, each channel being defined by a pair of walls extending from the vending tray; and
a cartridge disposed in at least one of the plurality of channels, the cartridge including an auger disposed in a sleeve, the cartridge having a length dimension substantially equal to a length dimension of the at least one of the plurality of channels and a width dimension substantially equal to a width dimension of the at least one of the plurality of channels, the sleeve further including a generally cylindrical sidewall and a base wall extending tangentially from the cylindrical sidewall.

2. The vending machine of claim 1 wherein the base wall extends parallel to a plane containing the longitudinal axis of the cartridge to substantially the width dimension of the at least one of the plurality of channels.

3. The vending machine of claim 1 wherein the cylindrical sidewall includes a gap extending along a portion of the circumference of the cylindrical sidewall.

4. The vending machine of claim 3 wherein the gap is located generally diametrically opposite the base wall.

5. The vending machine of claim 1 wherein the sidewall includes a length dimension substantially equal to a length dimension of the cartridge and a width dimension substantially equal to a width dimension of the cartridge.

6. The vending machine of claim 1 wherein the auger includes a helical ribbon.

7. A vending machine comprising:
a tray defining a plurality of channels;
an auger disposed in at least one of the plurality of channels, the auger being surrounded by a cylindrical sidewall; and
a base wall extending tangentially from the cylindrical sidewall, the cylindrical sidewall defining a gap generally opposite the base wall.

8. The vending machine of claim 7 wherein the length and width of the cylindrical sidewall is substantially equal to the length and width of the at least one of the channels.

9. The vending machine of claim 8 wherein the auger includes a helical ribbon.

10. A cartridge for use in a vending machine, the cartridge comprising:
a cylindrical sidewall;
an auger disposed in and generally surrounded by the cylindrical sidewall; and
a base wall extending tangentially from the cylindrical sidewall, the cylindrical sidewall including a means for restocking the cartridge.

11. The cartridge of claim 10 wherein the means for restocking includes a gap that extends for about 25% of the circumference of the cylindrical sidewall along the length of the cylindrical sidewall.
